(19) United States
(12) Patent Application Publication
(10) Pub. No.: US 2006/0085991 A1
(43) Pub. Date: Apr. 27, 2006

(54) Can opener

(75) Inventor: Jurgen Parlowski, Brooklyn, NY (US)

Correspondence Address: BIRCH STEWART KOLASCH & BIRCH, PO BOX 747, FALLS CHURCH, VA, 22040-0747, US

(73) Assignee: Bradshaw International, Inc., Rancho Cucamonga, CA (US)

(21) Appl. No.: 11/207,541

(22) Filed: Aug. 19, 2005

Related U.S. Application Data
(60) Provisional application No. 60/602,652, filed on Aug. 19, 2004.

(51) Int. Cl. B67B 7/46

(52) U.S. Cl. 30/400

(57) ABSTRACT

A can opener having a knob-shaped handle to be disposed over a can to be opened, a rotary cutting mechanism on a cutting head spaced from the handle, and a drive knob for the cutting mechanism on the side remote from the handle, the cutting head and drive knob being counterbalanced by the handle so that the center of gravity is over the can near the cutting mechanism. The handle has a flat, palm-engaging top surface, a beveled thumb-engaging surface along the upper edge near the cutting head, and a recessed side remote from the cutting head concavely tapering from the top surface to a flat lower side for engaging the top of the can near the cutting mechanism. The cutting head and drive knob are supported on the handle by parallel pins that bear on the rim of the can on opposite sides of the cutting mechanism.

### CROSS-REFERENCE TO RELATED APPLICATION

This non-provisional application claims priority under 35 U.S.C. §119(e) on U.S. Provisional Application No. 60/602,652 filed on Aug. 19, 2004, the entire contents of which are hereby incorporated by reference.

### BACKGROUND OF THE INVENTION

This invention relates to implements for removing the tops of cans, usually composed of metal, by cutting the top from the can. The invention relates more particularly to manually operable can openers that can be placed on the top of the can and having a cutting mechanism that is manually operated to travel around the typically curved top and open the can.

Can openers of a wide variety of types have been known and used for many years to open cans and gain access to their contents. These range from quite simple tools with cutting blades that puncture and cut the top, to more complex openers that can be secured to the top of the can and include a hand actuator for turning of a rotary cutting mechanism to sever the top from the can. One popular example of the more complex openers has “pliers” style handles that extend laterally from the side of the can, generally tangent to its curvature when the cutting mechanism is clamped on the rim of the can. The handles are gripped in one hand of the user as the other hand turns a crank, knob or other rotary actuator to produce the cutting action. A more recent type of can opener works with a cutting wheel that cuts along the outer rim of the can while a driving wheel runs along the inside and at the top of the rim. A support element holds the can to be opened at a desired angle to the can opener, this general type being shown in U.S. Pat. Nos. 4,782,594 and 5,946,811. Other known types of can openers, such as that shown in U.S. Publication No. A2001/0022030, are handle-shaped units which permit a change of the relative distance between the cutting wheel and the driving wheel when the opener is placed on the can, and a so-called “single-arm safety can opener” as shown in German Publication No. DE-4-20220076 (FIG. 1) with a single arm handle and a head that is an extension of and is constructed in one piece with the handle. A cutter is housed in the inner side of the head with a rotating, sliding axle, and a two-winged turning handle attaches to its opposite end and a u-shaped support element on the inner side of the head to provide stabilizing support on top of the rim. Various other can openers operate in generally the same manner.

### SUMMARY OF THE INVENTION

The can opener of the present invention has an improved handle or grip that is disposed on top of the can during operation, to be held by one hand of the operator above the can, with a cutting head that is engageable with the can and has a drive knob on the cutting head that is operable by the other hand of the operator to turn the cutter in engagement with the can. The handle counterbalances the cutting head and drive knob so that the center of balance or center of gravity of the opener in the operating condition is over the top of the can. Accordingly, the opener rests in a stable manner on top of the can in the operating position and the user can interrupt the operation and simply leave the opener in place on the can.

More specifically, the preferred embodiment of the invention shown herein has a cutting head that is engageable with the top of the can over the usual crimped rim around the top, an enlarged horn-shaped handle that is offset from the cutting head to lie over the top of the can, and an operating knob on the cutting head on the side opposite the handle. The horn-shaped grip has a generally flat top surface for engagement with the user's palm, the left hand of a right-handed user, and is ergonomically shaped to fit the user's hand and be held securely during use, somewhat like a door knob, with a beveled edge for engaging the user's thumb and a concavely tapering, undercut side opposite the cutting head for engagement with the user's fingers. The offset in the handle away from the cutting head and operating knob contributes to the counterbalancing, and produce a center of gravity that preferably is near the cutting mechanism.

Other aspects and advantages of the invention will become apparent from the following detailed description, taken in conjunction with the accompanying drawings.

### BRIEF DESCRIPTION OF THE DRAWINGS

FIG. 1 is a top perspective view of a can opener in accordance with the present invention;

FIG. 2 is a fragmentary top perspective view of the can opener of FIG. 1 being gripped and operated by the hands of a user in opening a representative upright can;

FIG. 3 is a fragmentary side elevational view of the parts in FIG. 2, only one of the user's hands being shown placing the opener on a can;

FIG. 4 is a fragmentary view similar to FIG. 3 from a different angle;

FIG. 5 is a side elevational view of the can opener alone, taken from the front side of FIG. 1;

FIG. 6 is a left side elevational view thereof;

FIG. 7 is a right side elevational view thereof;

FIG. 8 is a top plan view thereof, with different can outlines shown in phantom lines; and

FIG. 9 is a bottom plan view thereof.

### DETAILED DESCRIPTION

As shown in the drawings for purposes of illustration, the invention is embodied in a can opener 10 for use by a user, whose hands 11 and 12 are shown, to open cans such as the representative cylindrical can 13 shown in FIG. 2. This is accomplished by removing the top 14 from the can. Such cans typically have a rim 15 around the top that jams the top 14 to the body 17 of the can, and the can opener 10 cuts either the top or the sidewall along this rim to permit removal of the top.

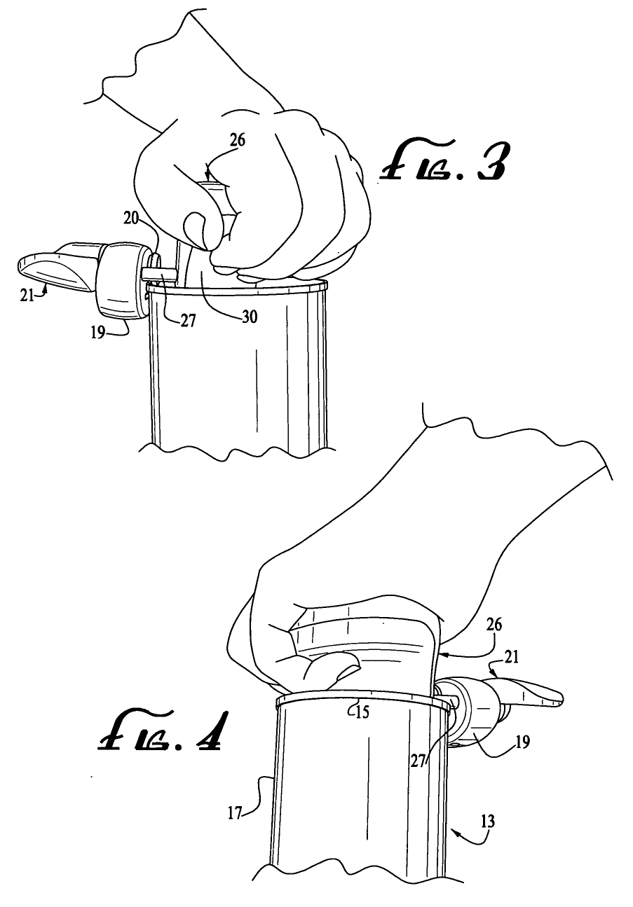

The can opener 10 has a cutting head, indicated generally at 18, that may be of basically conventional construction, including a block-shaped body 19 that can be positioned alongside the can 13 at the rim 15 and a rotary drive wheel 20 to be fitted over the can 13 and engaged with the inner side of the rim 15, as shown most clearly on FIGS. 3 and 8. A manually operable rotary drive knob 21, wherein a double-ended crank, and a cutter 22 are mounted on the body and the cutter is positioned to be pressed into the can as the drive wheel is turned to advance the cutting head 18 around the can. The drive knob 21 and the drive wheel 20 are on opposite ends of a drive shaft or axle that extends rotatably through the body, radially away from the can when the cutting mechanism is engaged, as shown in broken lines in FIGS. 8 and 9. The drive wheel is positioned on this shaft immediately inside the rim and the knob is offset laterally from the side of the can to lie on the opposite or outer side of the body 19.

The cutter 22 is a blade that projects inwardly from the substantially flat inner side of the body 19 of the cutting head and is spaced below the drive wheel 20 to engage the can immediately below the rim 15. The cutter may take various forms, but herein is a disk 23 (see FIG. 6) that is rotatably mounted in the body 19 of the cutter mechanism 18 and has a blade edge in the form of a sharp ridge 24 around the upper peripheral edge of the disk.

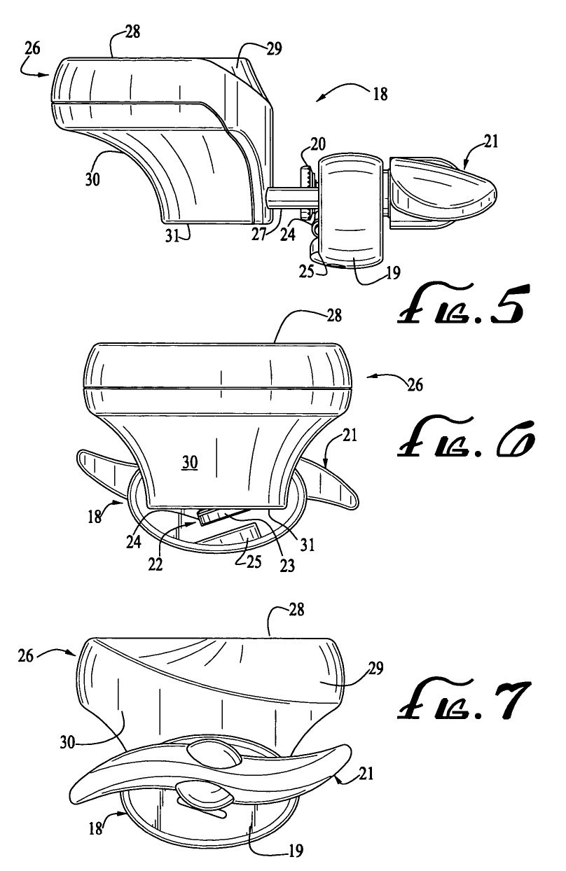

Below the cutter disk 23 is a guide rib 25 on the body 19 for engaging the sidewall 17 of the can and positioning the body 19 and the blade edge relative to the can. As can be seen in FIG. 5, the blade edge is spaced a very small lateral distance from the plane of the drive wheel 20 to permit the can rim 15 to be fitted between them as the can opener 10 is placed on the can. The outer side of the drive wheel is serrated as shown, for good driving engagement with the rim. This type of cutting mechanism is well known.

In accordance with the primary aspect of the present invention, the can opener 10 has a handle or grip, indicated generally at 26, in the form of an enlarged knob that is offset from the cutting head in the opposite direction from the drive knob 21 and is sized and positioned to overlie the top of the can 13 and to counterbalance the cutting head in use. This places the center of gravity of the opener 10 over the can 13, preferably near the cutting mechanism, when the opener is in the operating position on the can and the can is upright, so that the opener will be held in place by gravity alone if left unattended on the can.

The handle 26 is connected to the cutting head 18 by at least one support element 22 that supports the head on the handle and holds the adjacent sides of the handle and the head in spaced relation on opposite sides of a gap in which the drive wheel 20 is disposed. These sides preferably are disposed generally vertically when the opener 10 is in the operating position on top of an upright can 13 on a table top or counter, and two support elements 27 preferably are provided, in the form of parallel pins that are anchored at their opposite ends in the handle and the cutting head and extend substantially horizontally across the gap between them in the operating position. These support pins are positioned to lie just above, and bear on, the top edge of the rim of the can as shown in FIG. 2. This positions the cutting head 18 for engagement with the can and the handle 26 above the central portion of the can.

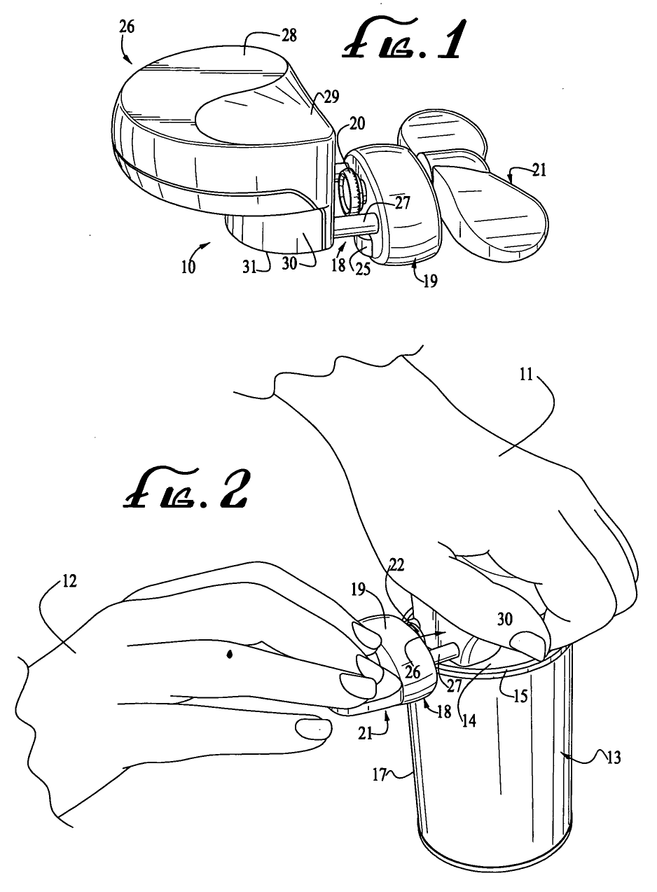

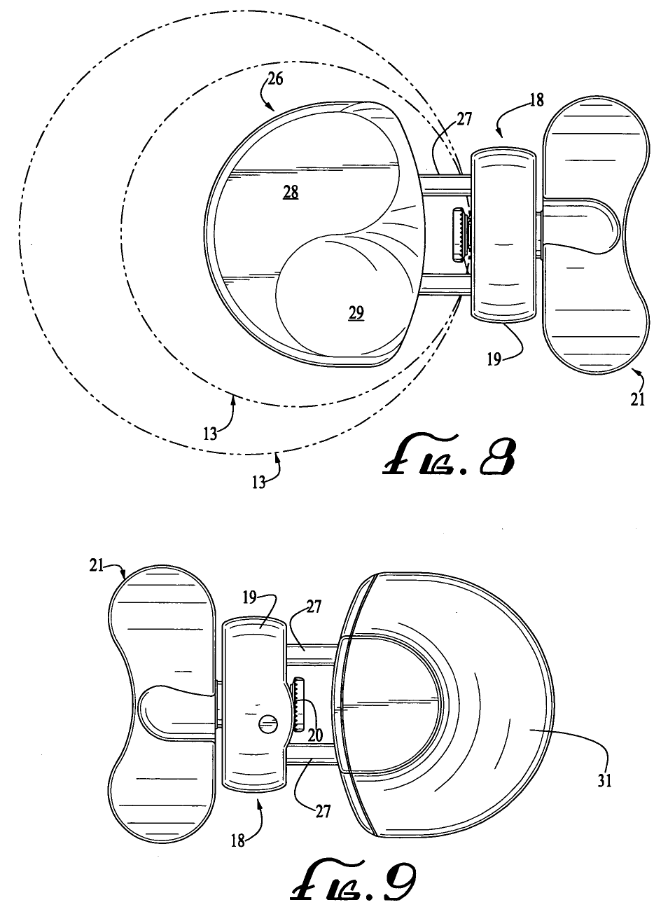

As can be seen most clearly in FIGS. 1 and 5 through 9, the handle 26 is generally horn-shaped or doorknob-shaped, having a flat top surface that is generally parallel to the top of the can in the operating position, to be engaged by the palm of a user's hand 11. A beveled upper edge portion 29 along the side of the top surface 28 of the handle is shaped to be engaged by the user's thumb, as shown in FIG. 2. This surface curves around the top surface 28 of the knob as shown in FIG. 8. The opposite side of the handle is undercut at 30 to receive the user's fingers as shown in FIGS. 3 and 4, curving concavely down. This curvature tapers the thickness of the handle downwardly to a relatively small leg-like stem with a flat lower side 31. This is close to the cutting head 18, as can be seen in FIGS. 1 and 5, and the knob-shaped upper portion of the handle is offset away from the cutting head 18.

Shaped in this manner, the handle 26 can be held in one hand, typically the left hand as shown in FIG. 3, and simply placed on top of a can 13 with the rim 15 of the can in the gap between the handle and the cutting head 18. The head is disposed alongside the top of the can, with the drive knob 21 projecting laterally outwardly and readily accessible to the other, or right, hand of the user, as shown in FIG. 2. The flat lower side 31 of the handle can be rested on top of the can, with the support pins resting on the rim 15.

It is important to emphasize that the cutting head 18 and the drive knob 21 are counterbalanced by the handle 26 so that the center of balance, or center of gravity, lies over the top of the can. This is accomplished by selecting the size and weight of the handle to make it sufficient to counterbalance the head 18 and the knob 21, and their various components, and establishing a center of gravity for the opener closer to the handle than to the cutting head, positioning the weight far enough toward the handle to counterbalance the projection of the cutting head from the can. Of course, the offset of the mass of the upper portion of the handle away from the stem of the handle and its flat lower side 31 assists in such counterbalancing, as well as being ergonomically desirable for ease of gripping.

Preferably, the weight distribution of the parts of the opener 10 is such that the center of gravity lies just inside, or to the handle side of, the rim 15 of the can. As a result, the can opener 10 can be left in place, unsupported, on top of the can and need not be held or removed if, for any reason, the opening of the can is interrupted. It also is important to note that the opener is completely safe and very simple and convenient to operate. Different sizes of cans are readily accommodated by the opener 10, as indicated in phantom lines in FIG. 8. The can 13 and a much larger can 13′ are engaged by the opener in the same manner.

From the foregoing, it will be evident that the present invention provides a novel and effective can opener 10 that can be placed quickly and easily on top of a can 13 to be opened, engaged with the rim 15 of the can with a simple downward motion, and held securely in place with the handle 26 under the palm of the user's hand and gripped as shown, while the user turns the drive knob 21 with the other hand to open the can. The counterbalancing of the cutting head 18 and drive knob 21 of the opener 10 by the offset handle 26 overlying the can makes the opener highly stable and easy to operate, and permits it to be left in place on top of the can at any point in the opening operation.

It also will be evident that, while one preferred embodiment has been illustrated and described in detail, various modifications and changes may be made within the scope of the invention.

I claim as my invention:

1. A can opener for removing the top of a can by cutting the can along a rim and around the top in a generally upright position by cutting the can, comprising:
a cutting head adapted to be positioned in an operating position alongside the top of the can with one side of the cutting head beside the top of the can, and having a cutting mechanism on said one side for engaging and cutting the can, and rotary drive knob projecting away from the cutting head on the side thereof opposite the cutting mechanism, said drive knob being drivingly connected to the cutting mechanism to operate the mechanism when the drive knob is rotated;
a handle for said can opener to be positioned over the top of the can when the cutting head is in said operating position, said handle comprising an enlarged knob having a flat top surface generally parallel to the top of the can in said operating position for engaging the palm of a user's hand, and an undercut side for engagement by the user's finders during gripping of the handle;
and at least one support element connecting said handle to said cutting head in spaced relation and forming a gap between said handle and said one side of said cutting head, said handle being sized and positioned by said support element to counterbalance said cutting head and said rotary drive knob and establish a center of gravity for the can opener that is over the top of the can;
whereby the can opener may be held over the can by said handle in the operating position and may be left at rest on top of the can.

2. A can opener as defined in claim 1 wherein the handle is joined to the cutting head by two support pins that extend across said gap to bear against the rim of the can in the operating position.

3. A can opener as defined in claim 1 wherein the center of gravity of said can opener in said operating position is over the cutting mechanism to lie over the can near the rim thereof.

4. A can opener as defined in claim 1 wherein said handle has a beveled edge alongside said flat top on the side thereof adjacent to the cutting head for engagement with the user's thumb.

5. A can opener as defined in claim 1 wherein said undercut side of said handle is a concavely tapered side and is on the side of the handle opposite said cutting head, whereby the top of the handle is offset away from the cutting head.

6. A can opener as defined in claim 1 wherein the adjacent sides of said handle and said cutting head are substantially vertical in said operating position, and said handle is connected to said cutting head by two support rods extending substantially horizontally across the rim of the can in said operating position and positioned to bear on the rim during the cutting operation.

7. A can opener as defined in claim 1 wherein said drive knob is a double-ended crank rotatably mounted on said cutting head by an axle that extends through the head and drives said cutting mechanism.

8. A can opener for removing the top of a can by cutting around the top, comprising:
a cutting head adapted to be positioned in an operating position alongside the top of the can with one side of the cutting head beside the top of the can and supporting a cutting mechanism for performing the cut;
a rotary drive knob on the cutting head for driving said cutting mechanism, said drive knob being disposed beside said cutting head on a side thereof remote from the can when the cutting head is in the operating position;
a knob-shaped handle for said can opener spaced from said one side of said cutting head and positioned to overlie the top of the can when the cutting head is in said operating position, said handle having an upper side for engaging a user's palm when the handle is held by the user, and having an underside for engaging the top of the can;
and at least one support element connecting said handle to said cutting head and supporting said cutting head and said drive knob on the handle;
said handle having sufficient weight to counterbalance the cutting head and the drive knob and establish a center of gravity for the can opener sufficiently close to the handle to lie over the top of the can in the operating position.

9. A can opener as defined in claim 8 wherein said handle has flat upper and lower sides and an undercut, concavely curved side facing away from the cutting head to offset the top of the handle away from the cutting head.

10. A can opener as defined in claim 8 wherein said cutting head and said drive knob are joined to said handle by two support pins that are anchored at opposite ends in the cutting head and the handle and are positioned to bear on the top of the can when the cutting head is in the operating position.

11. A can opener as defined in claim 10 wherein said handle is doorknob shaped, with an undercut side remote from the cutting head.

12. A can opener as defined in claim 11 wherein the handle is sized, shaped and positioned to position the center of gravity between the cutting mechanism and the handle, to lie over the can when the cutting mechanism is engaged.

13. A can opener as defined in claim 12 wherein the handle is sized, shaped and positioned to position the center of gravity close to the cutting mechanism.

14. A can opener having a cutting head including a cutting mechanism for removing the top of a can, a manually operable drive crank, and a handle for holding the cutting head in cutting engagement with a can to be opened, characterized by the position of the handle in spaced relation with the cutting head to lie over the top of the can during the cutting, and wherein the center of gravity of the can opener lies approximately over the cutting mechanism to lie over the can.

15. A can opener is defined in claim 14 further characterized by the position of the center of gravity being between the cutting mechanism and the handle, whereby the can opener may be left at rest in the cutting position.

16. A can opener as defined in claim 14 wherein the handle is generally doorknob-shaped and has a flat side for engagement with a user's palm, and recessed side remote from the cutting mechanism for engagement with a user's fingers.

17. A can opener as defined in claim 16 wherein said recessed side is concavely tapered to a small end surface opposite said flat side for engaging the top of a can.
